(19) United States
(12) Patent Application Publication
(10) Pub. No.: US 2015/0286409 A1
(43) Pub. Date: Oct. 8, 2015

(54) STORAGE SYSTEM CONFIGURATION ANALYSIS

(71) Applicant: NetApp, Inc., Sunnyvale, CA (US)

(72) Inventors: Anurag Sushil Chandra, Bangalore (IN); Venkata Ramprasad Darisa, Andhra Pradesh (IN); Mahmoud K. Jibbe, Wichita, KS (US)

(73) Assignee: NetApp, Inc., Sunnyvale, CA (US)

(21) Appl. No.: 14/247,636

(22) Filed: Apr. 8, 2014

(51) Int. Cl. G06F 3/06

(52) U.S. Cl. CPC G06F 3/0604; G06F 3/0629; G06F 3/0673

(57) ABSTRACT

In response to a request to perform an analysis of a storage system associated with a device, it is determined that the request indicates at least one of a proposed storage configuration, a configuration validation request, or a set of performance goals. Configuration data associated with the device is determined. The configuration data includes configuration data for an additional device. The analysis of the storage system is performed based, at least in part, on the configuration data associated with the device. Performing the analysis of the storage system comprises querying a database for entries associated with at least one of the device or the additional device.

### BACKGROUND

Aspects of the disclosures herein generally relate to the field of data storage, and, more particularly, to efficiently evaluating storage system configurations.

Far removed from the simplicity of a basic hard drive, today's storage systems can be exceptionally complex. Designing, configuring, and upgrading a storage system can involve many variables, including the size of individual disks, the type of disks, the amount of cache included with each disk, the number of controllers, the amount of cache included with each controller, logical volume size, etc. Further, determining the impact of a particular design or configuration choice on a particular storage system includes determining how the various components will interact during operation, resulting in even greater complexity. For example, consider a system that includes hundreds of hard drives, connected to potentially hundreds of controllers. An administrator might be tasked with determining whether using hard drives with a larger cache is worth a potentially substantial increase in cost. However, such a determination can involve variables as diverse as the size and layout of blocks on the disks, the speed of the interfaces between the hardware, the processing power of the controllers, etc. Further, administrators may not have all of the relevant information available, particularly when upgrading an existing storage system. Compiling all of the information can consume enough time that an incomplete analysis is performed, thus leaving open the possibility of negative impacts to system performance, a low benefit to cost ratio, etc.

The above issues are further exacerbated when the initial storage system is designed and configured by another entity. For example, a company might hire a third party that specializes in designing storage systems. The company might then have an administrator that is well-versed in the day-to-day operations of the storage system, but might not have the requisite knowledge to select appropriate upgrades or make configuration changes. While the company might have the third party determine what upgrades are appropriate, etc., additional inefficiencies may be encountered. For example, it may be difficult or costly for the third party to gather the relevant information about the storage system due to not having direct access to the storage system or having to send a person to the company's site. Further, any information from the initial design and configuration might be inaccurate, as the company might have performed upgrades and configuration changes already.

### Overview

Many different aspects of storage systems can be configured in numerous ways. For example, a single hard drive within a storage system can vary in capacity, spindle revolutions-per-minute, cache size, connectivity options, etc. Similarly, multiple hard drives can be grouped in various manners to form different volume configurations, controllers can be configured in various ways (cache size, processor speed, etc.), etc. Thus, the number of possible configuration permutations is great. Further, an administrator responsible for day-to-day operations of the storage system might not be familiar with the particular configuration of the storage system. As such, verifying aspects of potential configuration changes, like compatibility and performance, can be difficult.

A storage analysis system can perform operations to verify a storage system configuration. The functionality of the storage analysis system can be implemented in a variety of ways. For example, a request to perform an analysis of the storage system can indicate a proposed storage system configuration, a set of performance goals, and/or a request for validation of a current storage system configuration. The storage analysis system can determine potential incompatibilities, indicate potential improvements to a current or proposed configuration, determine the performance impact of a proposed configuration, and/or determine a configuration that meets indicated performance goals. Further, the storage analysis system can be distributed among the storage system, allowing for the actual analysis to be distributed among the various storage system components.

### BRIEF DESCRIPTION OF THE DRAWINGS

The disclosures may be better understood, and numerous objects, features, and advantages made apparent to those skilled in the art by referencing the accompanying drawings.

FIG. 1 depicts an example distributed storage system with a storage analyzer that analyzes requests made of the distributed storage system to determine the impact of the requests.

FIG. 2 depicts a flowchart of example operations for performing a storage configuration analysis.

FIG. 3 depicts example operations for performing a distributed storage configuration analysis of a hierarchically-arranged distributed storage system.

FIG. 4 depicts a flowchart of example operations for querying a support database using keywords.

FIG. 5 depicts a flowchart of example operations for determining configurations that meet performance goals and determining the performance impact of configuration changes.

FIG. 6 depicts an example computer system including a storage configuration analyzer.

### DETAILED DESCRIPTION OF EXAMPLE ILLUSTRATIONS

The description that follows includes example systems, methods, techniques, instruction sequences and computer program products that embody techniques of the disclosures herein. However, it is understood that the described aspects may be practiced without these specific details. For instance, although examples refer to Fibre Channel, other connectivity technologies (e.g., protocols) can be utilized, such as Small Computer System Interface (SCSI), Serial Attached SCSI (SAS), Internet SCSI (iSCSI), etc. In other instances, well-known instruction instances, protocols, structures and techniques have not been shown in detail in order not to obfuscate the description.

A storage analysis system can implement functionality to determine the configuration of a storage system and prospectively analyze the impact of changes to the storage system. Further, based on the type of analysis performed, the storage analysis system can provide a variety of feedbacks related to the changes. The storage analysis system can be further implemented in a distributed manner and utilize a variety of data sources to direct the analysis.

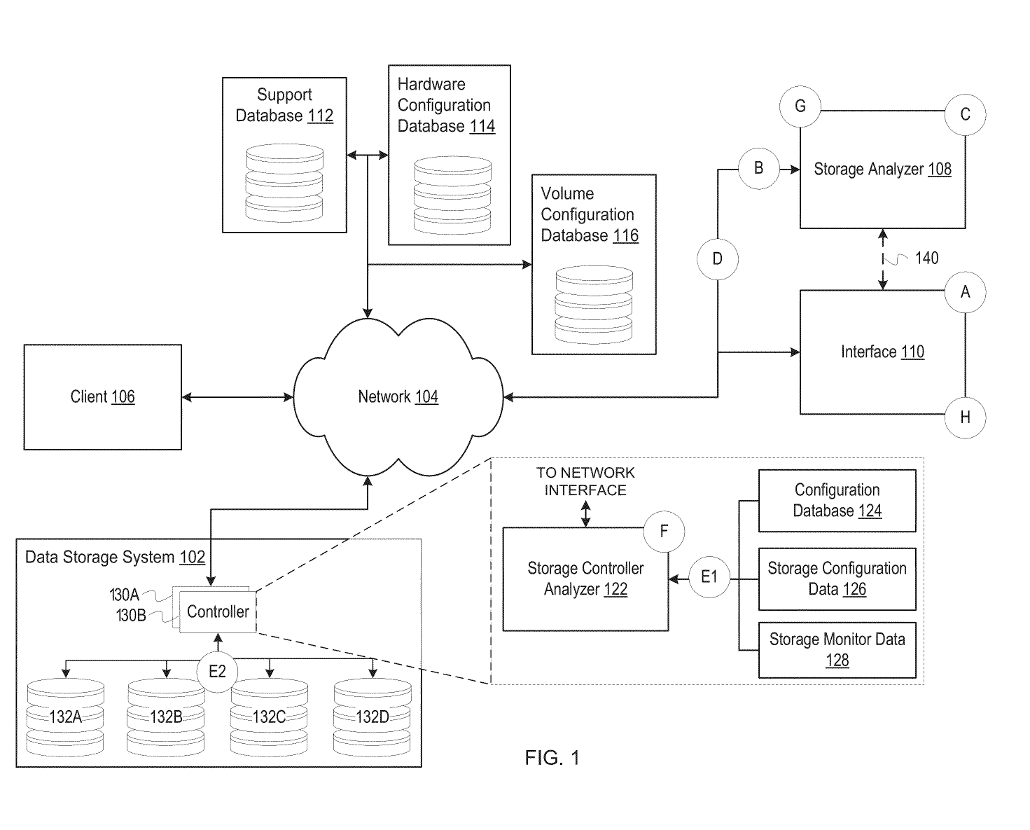

FIG. 1 depicts an example distributed storage system with a storage analyzer that analyzes requests made of the distributed storage system to determine the impact of the requests. FIG. 1 depicts a distributed storage system that includes a data storage system 102, a network 104, a client 106, a storage analyzer 108, and interface 110. The distributed storage system also includes a support database 112, a hardware configuration database 114, and a volume configuration database 116, collectively referred to herein as “the databases 112, 114, and 116”. The data storage system 102 depicted in FIG. 1 includes a pair of controllers 130A and 130B and a set of four storage devices 132A, 132B, 132C, and 132D. The controller 130A includes a storage controller analyzer 122, a storage configuration database 124, storage configuration data 126, and storage monitor data 128. The controller 130A can include multiple input/output (I/O) ports/interfaces (not depicted) and can support one or more connectivity/networking technologies, such as Ethernet, Fibre Channel, SCSI, the Internet Protocol (IP), etc.

FIG. 1 depicts interactions within the storage analysis system with respect to the described example storage analysis operations with labels A-D, E1-E2, and F-H. At stage A, a request for a storage configuration analysis is received by the interface 110. The request specifies whether the analysis should be an analysis of a storage configuration change, determination of a configuration that meets one or more goals, or validation of the current storage configuration. The data comprising the request varies depending on the analysis specified. For example, if the request specifies that a storage configuration change should be analyzed, the data that comprises the request indicates the storage configuration change, such as a device or group of devices and an indication of the new (or potential) storage configuration. If the new storage configuration included upgrading the amount of cache on the controller 130A, the request would indicate the controller 130A and the amount of cache that the controller 130A would be upgraded to.

At stage B, the interface 110 sends a request to the storage analyzer 108. The request is transmitted by the interface 110 over the network 104 or via a direct connection 140. The request sent from the interface 110 to the storage analyzer 108 can differ from the request received by the interface 110 at stage A. For example, the interface 110 can transform/translate various aspects of the request received at stage A into values that are more readily used by the distributed storage system. For example, device names might be translated into device identifiers, values specified in megabytes or gigabytes might be translated into bytes, etc.

At stage C, the storage analyzer 108 receives and processes the request from the interface 110. The specific processing involved can vary between implementations and based on the specific request. When the request indicates that a particular storage configuration change might be made, the storage analyzer 108 determines data about the particular storage device, such as brand and model. To determine data about the particular storage device, the storage analyzer 108 can query the device itself, a database, etc. The storage analyzer 108 also queries the support database 112 for information related to the particular device and/or proposed storage configuration change. For example, the support database 112 can include reports about compatibility issues, recommendations of certain storage configuration settings, restrictions against certain storage configuration settings, etc. The entries in the support database 112 can be associated with keywords, metadata about the particular devices (or protocols, etc.), indexes, etc. Thus, for example, if the request is related to a storage configuration change for a particular storage device, the storage analyzer 108 queries the support database 112 for entries related to the particular storage device's model number. The storage analyzer 108 also queries the support database 112 for entries related to the storage configuration change. For example, if the request indicates that the data storage system will be changed from using iSCSI to Fibre Channel, the storage analyzer 108 queries the support database 112 for entries related to Fibre Channel.

When keywords are used to query the support database 112 (or any other database), the storage analyzer 108 can use predetermined keywords associated with requests and/or determine appropriate keywords dynamically. For example, a request can be associated with a specific identifier or type. The support database 112 can associate the request identifier or type with a set of keywords that are associated with requests specifying the identifier or type. To determine the keywords dynamically, the storage analyzer 108 parses the request and any other data associated with the request to determine relevant terms.

The hardware configuration database 114 includes data associated with various hardware configurations. For example, the hardware configuration database 114 includes specific devices, their capabilities (such as protocols supported, amount of cache, etc.), and performance metrics. The hardware configuration database 114 also includes data associated with groups of components. For example, the hardware configuration database 114 might indicate that a hardware configuration consisting of a particular group of storage devices using a particular connectivity technology supports a particular maximum number of I/O operations per seconds (IOPS). Thus, the storage analyzer 108 queries the hardware configuration database 114 in a variety of scenarios. For example, if a request indicates a particular storage configuration change, the storage analyzer 108 queries the hardware configuration database 114 to determine the potential performance impact of the storage configuration change. If the request indicates that a particular performance goal is desired, the storage analyzer 108 queries the hardware configuration database 114 to determine one or more configurations that will meet the desired performance goals. The hardware configuration database 114 can also include relationships between components. Thus, the storage analyzer 108 can query the hardware configuration database 114 to determine additional keywords or data to use for querying the support database 112. This allows the storage analyzer 108 to find additional entries in the support database 112 that include information that might be relevant to the current request.

The volume configuration database 116 includes data associated with particular volume configurations, such as performance metrics. Thus, when a request indicates a change to a volume configuration, the storage analyzer 108 queries the volume configuration database 116 to determine the impact of the volume configuration change. Further, when a request indicates desired performance goals, the storage analyzer 108 can query the volume configuration database 116 to determine one or more volume configurations that support the desired performance goals.

At stage D, the storage analyzer 108 sends a request to the controller 130A for an analysis of the data storage system 102. Similar to the request sent from the interface 110 to the storage analyzer 108, the request sent from the storage analyzer 108 to the data storage system 102 can vary from the request sent to the storage analyzer 108 at stage B. For example, because the data storage system 102 comprises a subset of the components of the distributed storage system, the request sent to the controller 130A only includes aspects of the request related to an analysis of the data storage system 102. In other words, the request sent to the data storage system 102 only includes aspects of the request relevant to the perspective of the data storage system 102. The request sent to the data storage system 102 also includes data used to perform the analysis that might not otherwise be accessible to the controller 130A. For example, the controller 130A might not have access to the data in the support database 112. The storage analyzer 108 can thus include data from the support database 112 with the request sent to the controller 130A.

By sending a request for the controller 130A to perform an analysis of the data storage system 102, the storage analyzer 108 effectively distributes the analysis of the distributed storage system. Thus, for example, in implementations containing many different data storage systems and many different controllers, each data storage system can perform a portion of the analysis relevant to the particular data storage system. Thus, the storage analyzer 108 can be implemented without knowledge of specific variations between data storage systems (i.e., when the various data storage systems are heterogeneous). Further, instead of a large number of data storage systems requesting data from a central source (such as one or more of the databases 112, 114, and 116), the storage analyzer 108 is able to make a single request and distribute the relevant data to the individual data storage systems.

When the controller 130A receives a request to perform an analysis of the data storage system 102, the request to perform the analysis is passed to the storage controller analyzer 122 (hereinafter “controller analyzer 122”).

Stages E1 and E2 depict operations performed by the storage controller analyzer 122 to perform the analysis of the data storage system 102. Stage E2 describes collecting data from components of the data storage system 102 (such as the storage devices 132A-132D). Stage E2 is depicted as a separate stage from stage E1 because the data collection can occur at other times, such as when the data storage system 102 is configured or during the controller 130A boot process. Thus, the operations depicted at stage E2 can occur asynchronously to the analysis process.

At stage E1, the controller analyzer 122 queries data from the configuration database 124 and reads the storage configuration data 126 and storage monitor data 128. The configuration database 124 includes information about the configuration of the controller 130A and/or the storage devices 132A-132D, including the expected performance of various configurations, restrictions on various storage operations, etc. In other words, the configuration database 124 includes a subset of data from the hardware configuration database 114 that is specifically relevant to the controller 130A. The storage configuration data 126 includes data related to the configuration of the data storage system 102, such as the type of connection between the controller 130A and the storage devices 132A-132D, the amount of cache memory on the controller 130A, the configuration of the storage devices 132A-132D (such as drive formatting configuration and volume data), etc. The storage monitor data 128 includes statistics and other data about the operation of the controller 130A, such as the rate at which the controller 130A performs I/O operations, cache miss rate, etc. In other words, the storage monitor data 128 includes data that is recorded by a storage monitor component (not depicted). The recorded data can vary between implementations and can comprise any operational data.

At stage E2, the controller analyzer 122 queries data from the storage devices 132A-132D. The controller analyzer 122 can query a very diverse range of data from the storage devices 132A-132D, which can vary between implementations. For example, if the storage device 132A is a RAID array comprising multiple disks, the controller analyzer 122 might query the number of disks in the array, the particular RAID configuration, and data related to the individual disks (such as cache size, spindle revolutions-per-minute (RPM), etc.).

At stage F, the controller analyzer 122 performs the analysis of the data storage system 102. The analysis can vary between implementations and can also vary based on the particular analysis requested. For example, the controller analyzer 122 might be capable of analyzing the impact of changing the storage devices 132A-132D to be flash memory-based, increasing the amount of cache available to each storage device, etc. But if the storage devices 132A-132D are already flash memory-based or the request only indicates an analysis related to increasing the amount of cache available to each storage device, only the related subset of analyses might be performed.

At stage G, the storage analyzer 108 receives the results of the analysis from the storage controller analyzer 122 and performs further analysis based on said results. As described above, the storage analyzer 108 is likely better situated to perform analysis related to the global configuration (relative to the data storage system 102). For example, the storage controller analyzer 122 might determine that a particular storage configuration change will increase the maximum data throughput of the data storage system 102 by fifty percent. The storage controller analyzer 122 then indicates to the storage analyzer 108 the maximum data throughput of the data storage system 102. The storage analyzer 108 then utilizes the indicated maximum data throughput to determine if the various components of the network 104 are capable of supporting the indicated maximum data throughput.

Consideration of the global configurations can become increasingly important as the distributed storage system becomes increasingly hierarchical. For example, as described above, the distributed storage system can include more than one data storage system 102. Thus, in order to analyze some aspects of the entire distributed storage system, such as overall performance, at least one component should be aware of all data storage systems. If the analysis is solely performed within a data storage system controller, the data storage system that performs the analysis should be aware of the other data storage systems. However, by including an analysis component with a global view, such as the storage analyzer 108, the complexity of the data storage systems can be reduced, as the data storage systems can be implemented to restrict the analysis capabilities to those specific to the data storage system configuration.

Further, even when the distributed storage system only includes a single data storage system, various aspects of the distributed storage system external to the data storage system 102 can impact the analysis. For example, the particular networking technology used to communicatively couple the data storage system 102 to the client 106 can impact the particular capabilities of the entire distributed storage system. For example, as described above, an analysis might account for a scenario in which the data storage system 102 can output data at a faster rate or higher throughput than the network 104 can handle. Further, as the complexity of the network 104 increases (such as comprising a SAN, LAN, and WAN), the complexity of the analysis increases. While some implementations might enable the storage controller analyzer 122 to perform an analysis that takes into account factors external to the data storage system 102, some implementations employ the storage analyzer 108 to perform such an analysis instead.

Thus, further analysis by the storage analyzer 108 at stage G can include analysis relating to global aspects of the distributed storage system and/or completing any previous analysis performed in light of the results of the analysis performed by the storage controller analyzer 122. Further, some or all of the analysis previously performed by the storage analyzer 108, such as that described at stage C, can be performed at stage G instead. For example, some of the analysis described above involved the storage analyzer 108 retrieving data from the support database 112, including data related to the configuration of the data storage system 102. In order to retrieve data related to the configuration of the data storage system 102, the storage analyzer 108 was described as potentially querying the data storage system 102. However, the data storage system 102 can be configured to return configuration information with the results of the analysis performed by the storage controller analyzer 122. Thus, the storage analyzer 108 can delay some analysis until receiving the configuration information from the storage controller analyzer 122.

At stage H, the interface 110 communicates the results of the analysis with an appropriate party, such as the requestor of stage A. The specific communication technique can vary between implementations, analysis type, and party to which the results are communicated. For example, in some implementations, the interface 110 is a graphical user interface, thus allowing result data to be formatted into charts, graphs, and tables as appropriate. In some implementations, the interface 110 is a text interface, which may result in the interface 110 formatting the result data into a different format than if the interface was a graphical user interface. If the party to which the results are communicated communicates with the interface 110 via an API, the result data can be formatted to be consistent with the API specification.

While the descriptions above indicated some variations among implementations, descriptions of variations were minimized to avoid obfuscating the examples. The following discussion will provide further details on the numerous variations possible. While still not describing all variations, the descriptions below will provide a greater understanding of the ways in which aspects of the disclosures herein can vary.

The specific format of a request for a storage configuration analysis, along with the data comprising the request, can vary based on what type of analysis is being requested, the source of the request, etc. For example, a request can indicate that an analysis of a potential storage configuration change should be performed. Such a request can indicate specific components of the distributed storage system and specific changes to the configuration. Such a request can also, more generally, indicate potential storage configuration changes, such as indicating that a storage configuration analysis should be performed for general upgrades to storage devices that are part of the distributed storage system. For example, instead of analyzing the impact of changing from one type of connectivity technology to another, the request can indicate that an analysis cover all potential upgrades to the storage devices.

Requests for storage configuration analysis can come from a variety of sources. For example, in some implementations, the interface 110 can be configured to allow software or hardware to communicate with the interface 110, such as through an API. Software on any computing system communicatively coupled with the interface 110, such as the client 106, the storage analyzer 108, data storage system 102, etc., can be configured to periodically request, via the interface 110, analysis related to potential storage configuration changes. For example, various configuration settings, such as volume configurations, cache replacement policies, etc., can be dependent on how the data storage system 102 is being used at a particular period in time. In other words, some configuration changes can be optimized based on usage parameters that change over time. Thus, periodically requesting analysis related to storage configuration changes can allow optimizations of some storage configuration settings to be performed based on the current usage. As another example, any component of the distributed storage system (including components not depicted) can detect a configuration change, such as when a cable is removed or added. A component detecting such a change can request validation of the change using the interface 110, allowing the distributed storage system to detect potential errors or changes in performance even when not requested by a user.

Additionally, the interface 110, or another interface communicatively coupled to the interface 110, might be configured to allow for user interaction. For example, a user can indicate potential storage configuration changes to the interface 110 in order to gather data about the potential impact of the storage configuration changes. Similarly, the interface 110 can be configured to allow a user to enter and save actual storage configuration changes, as opposed to just indicating potential storage configuration changes. The act of saving a storage configuration change can thus act as a request for validation of the storage configuration. Further, instead of indicating specific potential storage configuration changes, the interface 110 might allow a user to request a general analysis analyzing all, or a subset of, potential storage configuration changes, as described above.

As described above, data identifying potential problems can be stored in the databases 112, 114, and 116. A component, such as the storage analyzer 108, can be configured to periodically request validation of the current storage configurations. By periodically requesting validation of the current storage configurations, any potential problems that might have been discovered and indicated in the databases 112, 114, and 116 can be identified. In other words, the storage analyzer 108 can be configured to periodically check for updates to the databases 112, 114, and 116 and perform an analysis based on any updates. Further, instead of periodically checking to see if changes have been made to the databases 112, 114, and 116, the interface 110 can be configured to receive indications that data has been updated. In other words, the interface 110 can be configured to allow the databases 112, 114, and 116 to notify the interface 110 when data has changed. In some implementations, an indication that data has been updated might merely indicate that an analysis should be performed. In some implementations, the indication that data has been updated might actually include the specific data that has changed. If the specific data that has changed is included, the operations described herein can be adapted to perform only operations relevant to the changed data. For example, if the changed data indicates that an error might occur when a particular communication protocol is used in conjunction with a particular disk block size, the analysis might be limited to determining if the communication protocol is used along with the particular disk block size instead of performing a complete analysis.

The interface 110 might also perform some preprocessing, pre-analysis, and/or data validation. For example, the interface 110 might have some data related to the current configuration of the data storage system 102, allowing the interface 110 to determine whether a particular request is valid or not. More particularly, consider a request to determine the impact of making a change to the first storage device 132A. The request might indicate a particular identifier associated with the storage device 132A, such as an IP address, volume number, device identifier, etc. The interface 110 might attempt to verify that the identifier is a valid identifier and identifies the storage device 132A. Similarly, if the request indicates a potential change to the connectivity technology used, the interface 110 might verify that the storage device 132A supports the new connectivity technology.

While the example depicted in FIG. 1 indicates that various aspects of a storage configuration analysis can be distributed to the data storage system 102, some aspects of the storage configuration analysis can be distributed to other components as well. For example, while the descriptions above describe the storage controller analyzer 122 as gathering data about the storage devices 132A-132D and performing an analysis based on the gathered data, the storage devices 132A-132D can be designed to perform part of the analysis as well. In other words, the storage controller analyzer 122 can allow the storage devices 132A-132D to perform some of the analysis themselves, similar to how the storage analyzer 108 might allow the storage controller analyzer 122 to perform the analysis of the data storage system 102.

Similarly, instead of requesting that the data storage system 102 perform part of the storage configuration analysis, the storage analyzer 108 might request data from the controller 130A and perform the analysis itself. By performing the analysis at the storage analyzer 108, the load on the controller 130A is reduced. Further, both the storage analyzer 108 and the controller 130A can perform some of the analysis relating to the data storage system 102. For example, the storage analyzer 108 might perform analysis of the data storage system 102 that would result in a large load on the controller 130A, while the controller 130A performs a portion of the analysis that does not result in a large load.

In general, the actual analysis of the data storage system 102 can be performed entirely by components of the data storage system 102, performed entirely by the storage analyzer 108, or performed by a combination of the components of the data storage system 102 and the storage analyzer 108. The specific implementation will vary based on many factors. For example, in an implementation with only one data storage system 102, it might be more efficient to integrate the storage analyzer 108 with the controller 130A. In an implementation with many data storage systems, it might be more efficient to perform the analysis for each data storage system using a controller within each data storage system, and performing a global analysis in the storage analyzer 108 (i.e., an analysis that incorporates aspects of the distributed storage system outside of each data storage system).

The analysis can be similarly divided up among components existing between the data storage system 102 and the storage analyzer 108. For example, the network 104 might comprise multiple networks, as described above. Each component network might have a network device associated with the individual component network that can perform a portion of the analysis. In this way the analysis performed by the distributed storage system can be distributed among its various components. The distribution can be hierarchical, resulting in components being responsible for the analysis as it applies to components lower in the hierarchy. Similarly, the retrieval of configuration information can also be distributed. For example, in some implementations, the storage analyzer 108 requests configuration information from the data storage system 102. The data storage system 102 then requests configuration information from the storage devices 132A-132D. The data storage system 102 then combines and sends the configuration information for the storage devices 132A-132D and the data storage system 102 itself back to the storage analyzer 108. In such an implementation, the storage analyzer 108 does not directly request configuration information from the storage devices 132A-132D, and thus does not need to be aware of the storage devices 132A-132D.

Although depicted individually, the databases 112, 114, and 116 can be combined into fewer databases or split into more databases. Further, other types of data sources can be used. Similarly, the configuration database 124, storage configuration data 126, and storage monitor data 128 might exist as part of the same data (such as a single database or data store) or be divided up variously.

The controllers 130A and 130B can be a redundant pair and/or can work in parallel (e.g., dual Simplex communication). The controllers 130A and 130B can be configured identically or differ. When configured as a redundant pair, one controller of the controllers 130A and 130B can be the “active” controller. When configured to operate in parallel, one controller of the controllers 130A and 130B can be configured as the primary controller. The operations described herein can be performed by the active controller, the primary controller, or any other controller. Additionally, some implementations can include more than two controllers, in which the controllers can be configured to function as redundant controllers or to operate in parallel, similar to a configuration with a pair of controllers. Similarly, some implementations might only have a single controller. The discussion herein describes operations as being performed by the first controller 130A, but some or all of the operations can be performed by the other controller 130B. The data storage system 102 configuration can vary among implementations as well. For example, the data storage system 102 can be a network-attached storage (NAS) device with one hard drive, a storage area network (SAN) system with multiple hard drives in a RAID configuration, an enterprise storage system including multiple flash/hard drive hybrid arrays connected to redundant controllers, etc. The storage devices 132A-132D can vary as well. For example, the storage devices 132A-132D can be individual drives, including flash drives. The storage devices 132A-132D can also be drive enclosures containing one or more drives, including hard drives, solid state drives, or a combination thereof. Drive enclosures can be individual components or combined with other drive enclosures as an integrated system.

The controller analyzer 122 can be part of the hardware, software, and/or firmware that implements the storage-related functionality. The controller analyzer 122 can also be hardware, software, and/or firmware that is partly or wholly independent of the hardware, software, and/or firmware that implements the storage-related functionality. For example, some controller implementations might include a single processor that executes instructions to perform functionality including read and write operations as well as functionality to perform analyses of the data storage system 102. Some controller implementations might include multiple processors, with one or more processors executing instructions to perform functionality including read and write operations and one or more other processors executing instructions to perform analyses of the data storage system 102.

The network 104 can comprise multiple communicatively coupled networks, such as a local area network, a storage area network, and the Internet. For example, the data storage system 102 might communicate with the client 106 over a SAN implemented using Fibre Channel, while the data storage system 102 might communicate with the storage analyzer 108 over the Internet, utilizing Ethernet and IP. Or, as another example, the SAN can communicate with a LAN (local area network) which, in turn, communicates with the Internet. Further, components of the distributed storage system can be coupled directly with other components. For example, the storage analyzer 108 can be coupled directly to the interface (as depicted by dashed line 140), such as a user interface displayed on a monitor attached to the storage analyzer 108 (or a computing system hosting the storage analyzer 108).

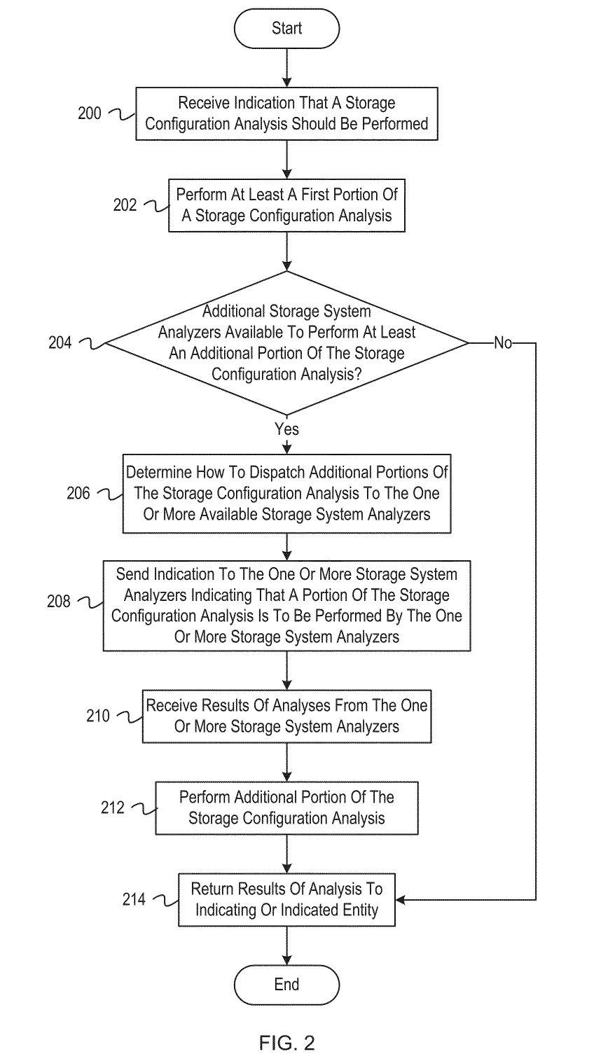

FIG. 2 depicts a flowchart of example operations for performing a storage configuration analysis. The operations depicted in FIG. 2 can be performed by the storage analyzer 108 and/or the storage controller analyzer 122 depicted in FIG. 1, but is not limited to the implementations described above.

At block 200, a storage analyzer receives an indication that a storage configuration analysis should be performed. An indication that a storage configuration analysis should be performed can be any of a request to perform a storage configuration analysis, an indication that a storage configuration is being or might be changed, an indication that information related to the storage system has changed, etc. The indication that the storage configuration analysis should be performed can come from software, hardware, a user, etc. The indication includes data that facilitates the storage configuration analysis. For example, a request to perform the storage configuration analysis can include a list of devices impacted by a storage configuration change and an indication of what change is being made (or considered). An indication that information related to the storage system has changed might include information indicating what components might be impacted by the changed information and other indications of what the information is related to. After the storage analyzer receives the indication that the storage configuration analysis should be performed, control then flows to block 202.

At block 202, the storage analyzer performs at least a first portion of a storage configuration analysis. Whether the storage analyzer performs a portion of the storage configuration analysis or all of the storage configuration analysis can vary depending on the storage system configuration and the particular storage analyzer. For example, if the storage analyzer is the only storage analyzer in the storage system capable of performing the storage configuration analysis, the storage analyzer performs the entire analysis. If other storage analyzers are capable of performing at least some of the storage configuration analysis, the storage analyzer might only perform some of the storage configuration analysis. However, even in implementations in which other storage analyzers are capable of performing at least some of the storage configuration analysis, the storage analyzer might perform the entire storage configuration analysis. Further, the storage analyzer might not perform any substantive analysis, but might perform operations more akin to “pre-processing”. For example, the storage analyzer might gather data used to perform the analysis without actually performing the analysis, instead passing the data on to other storage analyzers that perform the analysis incorporating the gathered data. For the purposes of the descriptions herein, such “pre-processing” will be considered to be part of the analysis. After performing at least the first portion of the storage configuration analysis, control then flows to block 204.

At block 204, the storage analyzer determines whether other storage analyzers are available to perform at least an additional portion of the storage configuration analysis. To make such a determination, the storage analyzer can access configuration data that indicates the availability of other storage analyzers or dynamically determine the availability of other storage systems by transmitting an identification request. A storage analyzer that received the identification request and was available to perform at least an additional portion of the storage configuration analysis can then send an acknowledgement back to the transmitting storage analyzer. Similarly, available storage analyzers might implement a form of zero configuration networking, allowing the available storage analyzers to announce their availability to the storage analyzer. If the storage analyzer determines that other storage analyzers are available to perform at least an additional portion of the storage configuration analysis, control then flows to block 206. If the storage analyzer determines that no other storage analyzers are available to perform at least an additional portion of the storage configuration analysis, control then flows to block 214.

At block 206, the storage analyzer determines how to dispatch the additional portions of the storage configuration analysis to the set of one or more available storage analyzers. The storage analyzer can determine the capabilities of each of the available storage analyzers. The storage system can comprise many different types of components, such as storage controllers, storage devices, networks and network devices, etc. Each component can be capable of performing a particular portion of the storage configuration analysis. In other words, each component of the storage system may differ in its capabilities, based on the purpose of the component, component type, component version, etc. The storage analyzer determines the capabilities of the available storage analyzers in order to determine what portion of the analysis each available storage analyzer is to perform. After the storage analyzer determines how to dispatch the additional portions of the storage configuration analysis to the one or more available storage analyzers, control then flows to block 208.

At block 208, the storage analyzer sends an indication to the one or more available storage analyzers indicating that a portion of the configuration analysis is to be performed by the one or more available storage analyzers. The particular indication can vary between implementations and based on the capabilities of the individual storage analyzers. For example, in some implementations, an indication might explicitly detail the various analysis operations that are to be performed. In some implementations, an indication might include data that can be used to facilitate the analysis. The storage system might send one indication to all of the available storage systems, multiple identical indications to all of the available storage systems, or different indications to the available storage analyzers. After the storage analyzer sends an indication to the one or more available storage analyzers, control then flows to block 210.

At block 210, the storage analyzer receives results of the analyses performed by the one or more available storage analyzers. The results can vary between implementations and between particular storage analyzers. For example, the received results can include statistical data, estimated performance values, measured performance values, configuration information, etc. The received results may also comprise results from additional storage analyzers. Consider a hierarchy of components, such as a storage analyzer, controller, and storage devices. A component at the second level of the hierarchy (e.g., controller) might receive results from several components at the third level of the hierarchy (e.g., storage devices). The component at the second level of the hierarchy can then combine the received results with its own analysis and send the combined results to a component at the first level of the hierarchy. After the storage analyzer receives the results of the analyses performed by the one or more available storage analyzers, control then flows to block 212.

At block 212, the storage analyzer performs an additional portion of the storage configuration analysis. The additional analysis performed by the storage analyzer might include performing analysis based on the results received at block 210. For example, a storage analyzer might determine whether a network has performance sufficient to handle the output of a data storage system. Also, a storage analyzer might retrieve data based on the results received at block 210, such as using configuration information to query a support database. In some implementations, the additional portions of the storage configuration analysis may not be substantive analysis. For example, the storage analyzer might format the results received at block 210 for further use while not actually using the results. Similar to the “pre-processing” described at block 202, non-substantive analysis performed after receiving the results at block 210 might be more akin to “post-processing”, and is herein considered to be part of the analysis. The storage analyzer might perform both substantive analysis and post-processing operations at block 212. After the storage analyzer performs the additional portion of the storage configuration analysis, control then flows to block 214.

Control flowed to block 214 if it was determined, at block 204, that no other storage analyzers were available to perform at least an additional portion of the storage configuration analysis. Control also flowed to block 214 from block 212. At block 214, the storage analyzer returns the results of the storage configuration analysis to the entity that indicated that the storage configuration analysis should be performed or to another entity indicated as one that should receive the results. The technique used to return the results can vary between implementations and based on the particular entity. For example, the results may be actively returned (or sent/transmitted) to the entity, such as responding to a request via an API. The results may be passively returned (or sent/transmitted) to the entity, such as by writing the results to a particular location (e.g., a file), allowing the entity to read the results from the particular location. After the storage analyzer returns the results of the storage configuration analysis to the entity, the process ends.

The analysis operations of a hierarchically-arranged distributed storage system can be further described with respect to a particular implementation.

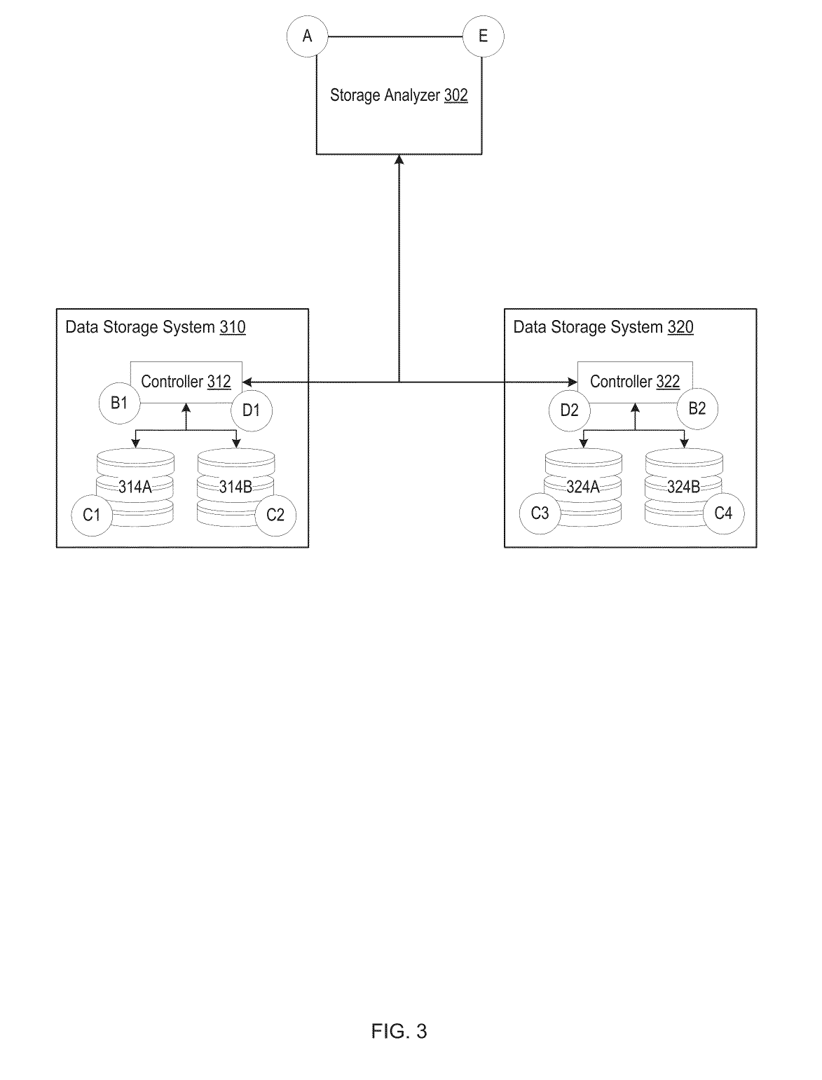

FIG. 3 depicts example operations for performing a distributed storage configuration analysis of a hierarchically-arranged distributed storage system. FIG. 3 includes a storage analyzer 302, a first data storage system 310, and a second data storage system 320. The first data storage system 310 includes a controller 312 and two storage devices 314A and 314B. The second data storage system 320 includes a controller 322 and two storage devices 324A and 324B. The storage devices 314A, 314B, 324A, and 324B are disk arrays containing multiple individual non-flash hard drives (not depicted individually).

The operations depicted in FIG. 3 include a subset of the operations depicted in FIGS. 1 and 2. In particular, the operations depicted in FIG. 3 provide further details related to the act of distributing the storage configuration analysis between components within a hierarchically-arranged distributed storage system. As such, while some operations described above are not discussed in relation to FIG. 3, actual implementations can perform all or some of the operations described above. Further, for the purposes of FIG. 3, it is assumed that the storage analyzer 302 received a request for a storage configuration analysis that indicated a proposed storage configuration change including upgrading the individual non-flash hard drives of the storage devices 314A, 314B, 324A, and 324B to flash-based hard drives.

Stages B, C, and D each comprise parallel sub-stages (B1 and B2, D1 and D2, etc.) representing distributed portions of the storage configuration analysis. For the purposes of FIG. 3, it is assumed that data storage system 310 and its components are configured the same as data storage system 320 and its components. Thus, the operations performed at the various sub-stages are assumed to be the same for the respective components. For example, the operations performed by the controller 312 at stage B1 are the same as the operations performed by the controller 322 at stage B2. As such, the descriptions below will not describe each sub-stage individually.

At stage A, the storage analyzer 302 determines that the controllers 312 and 322 are each capable of performing a portion of the storage configuration analysis related to the data storage systems 310 and 320, respectively. Thus, the storage analyzer 302 forms requests indicating the particular portion of the storage configuration analysis that should be performed by the individual controllers 312 and 322. In particular, each request indicates that the proposed storage configuration change includes upgrading non-flash hard drives to flash-based hard drives. Due to the distributed nature of the operations, the request does not specify any details regarding the actual storage devices 314A, 314B, 324A, and 324B, allowing the individual controllers 312 and 322 to determine the proper application of the request. In other words, the storage analyzer 302 relies on limited information about the data storage systems 310 and 320 when delegating the storage configuration analysis to the data storage systems 310 and 320. Once the requests are formed, the storage analyzer 302 sends the individual requests to the respective data storage system.

At stage B1, the controller 312 receives and processes the request from the storage analyzer 302. To process the received request, the controller 312 determines the particular storage configuration change indicated by the request. In this instance, the controller 312 extracts the data indicating that the proposed storage configuration change includes upgrading non-flash hard drives to flash-based hard drives. The controller 312 further processes the request by determining what operations are to be performed by the controller 312 in order to effectuate the storage configuration analysis. In this particular instance, the controller 312 determines that the storage devices 314A and 314B can perform the storage configuration analysis as it relates to upgrading the hard drives. Similar to the operations performed by the storage analyzer 302, the controller 312 forms individual requests for the storage devices 314A and 314B. The formed requests indicate that the storage devices 314A and 314B should perform operations that include analyzing the impact of upgrading non-flash hard drives to flash-based hard drives. After forming the requests, the controller 312 transmits the requests to the respective storage devices 314A and 314B.

At stage C1, the storage device 314A receives, processes, and effectuates the request to perform the storage configuration analysis. The storage device 314A processes the request by extracting the data indicating that the proposed storage configuration change includes upgrading non-flash hard drives to flash-based hard drives. To effectuate the request, the storage device 314A determines which hard drives within the storage device 314A are non-flash hard drives. The storage device 314A determines performance metrics for the non-flash hard drives, such as the maximum throughput, data transfer rate, etc. The storage device 314A can also analyze the volume configuration. For example, the storage device 314A might determine that the hard drives in the storage device 314A are configured at a particular RAID level. The storage device 314A can then determine, based on the performance metrics for the non-flash hard drives (and potentially flash-based hard drives) and the RAID level, performance metrics for the entire storage device 314A. For example, the maximum throughput of the storage device 314A might differ depending on whether the hard drives are configured as a RAID level 1 or RAID level 5. The performance metrics of the current configuration might also be determined based on actual measured data. For example, the storage device 314A might include a device monitor that records statistics about the storage device 314A performance.

Once the performance metrics of the current storage device 314A configuration are determined, the storage device 314A can determine the impact of upgrading the non-flash hard drives to flash-based hard drives. The storage device 314A can refer to estimated performance metrics for flash-based hard drives, for example, or actual measured performance if one or more of the hard drives in the storage device 314A are already flash-based hard drives. The storage device 314A then determines the overall performance metrics for the storage device 314A itself based on the analysis of the proposed upgrade. The storage device 314A compiles the results of the analysis in a format that is compatible with the controller 312. The storage device 314A can include other data, besides the performance metrics, in the results of the analysis. For example, the storage device 314A can include data indicating whether some of the existing hard drives were flash-based (i.e., indicate how many drives needed to be upgraded). The storage device 314A then sends the results of the analysis to the controller 312.

At stage D1, the controller 312 receives the results from the storage devices 314A and 314B and performs further analysis based on the results. For example, the results from the storage device 314A might indicate that the proposed storage configuration change will increase the performance of the storage device 314A by ten percent. Similarly, the results from the storage device 314B might indicate that the proposed storage configuration change will increase the performance of the storage device 314B by twenty percent. Based on these results, the controller 312 can determine that overall performance of the storage devices 314A and 314B together will improve fifteen percent. However, the analysis performed by the controller 312 further incorporates the capabilities of the controller 312. Thus, for example, the controller 312 can factor in the performance of the interconnect between the storage devices 314A and 314B and the controller 312, the performance of a cache used by the controller 312, etc. In other words, given the performance of the storage devices 314A and 314B, the controller 312 can determine whether other aspects of the data storage system 310 will result in an inability to realize the full impact of the proposed changes. For example, the connectivity technology used to connect the storage devices 314A and 314B to the controller 312 may result in a bottleneck that limits the increase in performance of the storage devices 314A and 314B combined to ten percent.

The controller 312 compiles the results of the analysis at stage D1 into a format compatible with the storage analyzer 302. The controller 312 can indicate, in the results, the performance increase of the storage devices 314A and 314B alone as well as the performance increase of the data storage system 310 as a whole. Consistent with the examples provided above, the results would indicate that the combined performance increase of the storage devices 314A and 314B is fifteen percent and the performance increase of the data storage system 310 is ten percent. By providing the individual changes in performance, the controller 312 enables the storage analyzer 302 to determine that additional changes can be made to realize the full impact of the proposed changes. Further, in some implementations, the controller 312 itself can indicate that a problem with the connectivity technology used exists that limits realization of the full performance gain possible with the proposed configuration changes. After compiling the results of the analysis, the controller 312 sends the results to the storage analyzer 302.

At stage E, the storage analyzer 302 receives the results of the analyses performed by the controllers 312 and 322 at stages D1 and D2, respectively. The storage analyzer 302 also performs further analysis based on the received results, similar to the analysis described above at stage D1. For example, the storage analyzer 302 can extract the results from the controller 312 and 322, determining that the overall increase in performance for both data storage systems 310 and 320 together is ten percent. Further analysis by the storage analyzer 302, however, might determine that the connectivity technology used to connect the data storage systems 310 and 320 with the rest of the distributed storage system limits the performance increase to five percent.

Thus, based on the results of the portions of the analysis performed by the storage devices 314A, 314B, 324A, and 324B, and the controllers 312 and 322, the storage analyzer 302 determines at least three aspect of the proposed storage configuration change. First, the storage analyzer 302 determines that the performance of the storage devices 314A, 314B, 324A, and 324B, together, will increase by fifteen percent. Second, the storage analyzer 302 determines that the performance of the data storage systems 310 and 320, together, will increase by ten percent. Third, the storage analyzer 302 determines that the performance of the distributed storage system, overall, will increase by five percent.

However, the storage analyzer 302 is able to further determine at least two other aspects based on the portions of the analysis performed by the storage devices 314A, 314B, 324A, and 324B, and the controllers 312 and 322. First, the storage analyzer 302 determines that the connectivity technology used to connect the storage devices 314A, 314B, 324A, and 324B to the controllers 312 and 322 results in a bottleneck, reducing realized performance by five percent. Second, the storage analyzer 302 determines that the connectivity technology used to connect the data storage systems 310 and 320 to the distributed storage system results in an additional bottleneck, further reducing realized performance by an additional five percent. The storage analyzer 302 can utilize these results to suggest other storage configuration changes that will allow greater realization of the performance increases associated with the proposed storage configuration changes.

While the example depicted in FIG. 3 describes a configuration in which the storage devices 314A, 314B, 324A, and 324B are not flash-based hard drives, the analysis is similar when one or more of the storage devices 314A, 314B, 324A, and 324B are flash-based hard drives. For example, if a subset of the storage devices 314A, 314B, 324A, and 324B are flash-based hard drives, the analysis would only factor upgrading the subset of the storage devices 314A, 314B, 324A, and 324B that are not flash-based. Similarly, if all of the storage devices 314A, 314B, 324A, and 324B are flash-based hard drives, the analysis can indicate that the upgrade is unnecessary, while still determining that additional performance gains can be had by upgrading other aspects of distributed storage system.

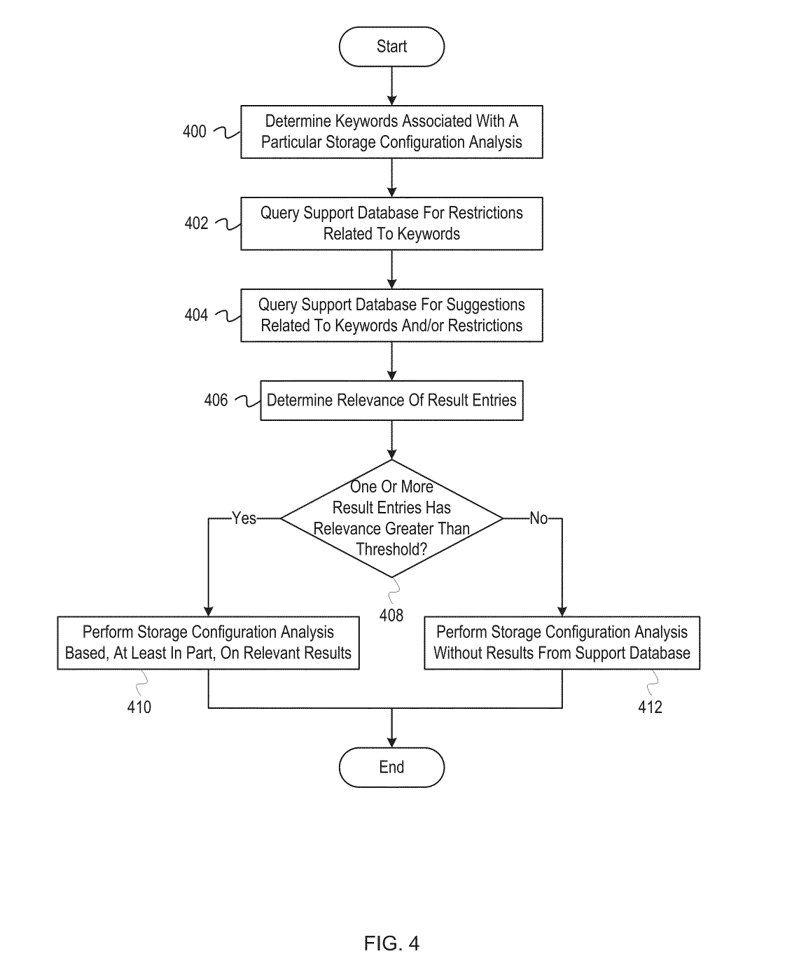

FIG. 4 depicts a flowchart of example operations for querying a support database using keywords. The operations depicted in FIG. 4 can be performed by the storage analyzer 108 and/or the storage controller analyzer 122 depicted in FIG. 1, but is not limited to the implementations described above.

At block 400, a storage analyzer determines keywords associated with a particular storage configuration analysis. Keywords associated with the storage configuration analysis can be determined in a variety of ways. For instance, a storage analyzer can analyze a request to determine keywords associated with the request. As an example, the storage analyzer might use natural language processing on a request to determine keywords. The storage analyzer might also determine storage analyzers (hardware or software) that are indicated in the request. For example, the request might indicate that the firmware for a particular controller might be upgraded to a newer version. The storage analyzer determines that the brand and model of the controller, the configuration of all devices communicatively coupled to the controller (such as brand and model of the various devices), and the version number of the firmware are keywords. The storage analyzer might also rely on additional databases to provide keywords. For example, a request for a storage system analysis might not include all of the relevant configuration data for devices communicatively coupled to a controller. Thus, the storage analyzer might query a configuration database to determine the configuration of relevant devices. Further, some requests or particular storage configuration analyses might include a predetermined set of keywords. For example, if the request indicates a controller might be upgraded to a new version of firmware, the term “upgrade” might be considered a keyword. After determining the keywords associated with the storage configuration analysis, control then flows to block 402.

At block 402, the storage analyzer queries a support database for restrictions related to the keywords. The restrictions in the support database indicate, for example, restrictions on using particular components, protocols, etc. If the storage analyzer determined that “Fibre Channel” was a keyword at block 400, the storage analyzer queries the support database for restrictions related to the keyword “Fibre Channel”. For example, the support database might indicate that an error exists for a particular controller model when the controller is connected to a network using Fibre Channel and a certain I/O block size is used. If a request for a storage configuration analysis indicates that a controller might be upgraded to the particular technology, the storage analyzer might query the support database using the controller model and the particular technology. The support database then returns the support database entries related to the determined keywords, including the result indicating the presence of the error. After the storage analyzer queries the support database for restrictions related to the keywords, control then flows to block 404.

At block 404, the storage analyzer queries the support database for suggestions related to the keywords and/or restrictions. The suggestions in the support database indicate, for example, suggestions a user or administrator should take into account when implementing technology associated with the keywords or restrictions. For example, if the storage analyzer determined that “Fibre Channel” was a keyword at block 400, the storage analyzer queries the support database for suggestions related to the keyword “Fibre Channel”. In response, the support database might return an entry indicating that a particular Fibre Channel cable should be used. Entries in the support database might indicate whether they are restrictions or suggestions. The storage analyzer can query the support database for entries that include the determined keywords and indicate that the query is directed to suggestions as opposed to restrictions. Further, the support database can be implemented such that suggestion entries related to particular restriction entries are linked. For example, if an error exists for a particular combination of hardware, a restriction entry might exist in the support database indicating that the error can occur. The entry corresponding to the restriction can include an indication that another entry includes a suggestion for remedying the error. After the storage analyzer queries the support database for suggestions related to the keywords and/or restrictions, control then flows to block 406.

At block 406, the storage analyzer determines the relevance of the result entries returned from the support database. The determination of relevance of search results can be implemented in a variety of ways. For example, the relevance of an entry might be defined as the total number of times the keywords appear in each of the entry. In other words, the more times each keyword appears, the more relevant the particular result might be. The relevance of an entry might be determined by assigning a weight to each of the keywords, thus allowing the relevance to take into account the importance of a keyword. The storage analyzer might determine the relevance based on the number of unique keywords that appear in the entry. Some definitions of relevance might take into account other values as well, such as how recently a result entry was updated, how many times the result entry was viewed, etc. Further, the storage analyzer might combine multiple techniques for determining relevance. The storage analyzer might represent the relevance in a variety of ways, such as assigning it a particular value, indicating an entry as “relevant” or “not relevant”, etc. After the storage analyzer determines the relevance of the result entries returned from the support database, control then flows to block 408.

At block 408, the storage analyzer determines if one or more of the result entries have a relevance greater than a threshold. For example, the storage analyzer might have determined that the keywords associated with a storage configuration analysis were “drive”, “flash”, “upgrade”. If the storage configuration analysis were related to determining the performance impact of upgrading a storage device to use flash drives, the keyword “drive” might result in many low relevant entries. For example, the keyword “drive” might return entries that only describe hard drives (i.e., non-flash drives). Thus, in order to reduce the results to those most likely related to the actual purpose of the storage configuration analysis, the storage analyzer might discard result entries that do not have a relevance greater than a threshold. For example, if the storage analyzer determines relevance based on the number of unique keywords associated with a result entry, an entry that contains one of the aforementioned keywords might be determined to be thirty-three percent relevant, an entry that contains two of the aforementioned keywords might be determined to be sixty-six percent relevant, and an entry that contains all three of the aforementioned keywords might be determined to be ninety-nine percent relevant. The threshold can then be used to filter the result entries based on the relevance. The threshold itself can be predetermined or determined dynamically. For example, testing and experimentation may determine that a particular threshold produces the best results. Or, the storage analyzer might determine the threshold based on the number of results returned, the number of keywords, etc. If the storage analyzer determines that one or more of the result entries has a relevance greater than the threshold, control then flows to block 410. If the storage analyzer determines that no result entries have a relevance greater than the threshold, control then flows to block 412.

At block 410, the storage analyzer performs a storage configuration analysis based, at least in part, on the results with a relevance greater than the threshold. For example, a request for a storage configuration analysis can indicate that a controller might be upgraded to use a particular technology. The storage analyzer queries the support database based on the controller model and the particular technology. An entry is returned indicating that upgrading the controller to use the particular technology might result in a bug. During the storage configuration analysis, the storage analyzer determines whether another entry in the support database (such as one returned by at block 404) indicates a workaround for the error. If no additional entry exists, the storage configuration analysis issues an error notification, indicating that the upgrade should not be performed. If an additional entry exists, the storage configuration analysis issues a warning, indicating that there is a potential issue that can be fixed. How the relevant results impact the storage configuration analysis can vary between implementations based on the results returned, the particular storage configuration analysis, etc. After the storage analyzer performs the storage configuration analysis based, at least in part, on the results with a relevance greater than the threshold, the process ends.

Control flowed to block 412 if, at block 408, it was determined that no result entries had a relevance greater than the threshold. At block 412, the storage component performs a storage configuration analysis without using the returned results. In some implementations, if no results are determined to be relevant, no further analysis is performed. After the storage component performs the storage configuration analysis without using the returned results, the process ends.

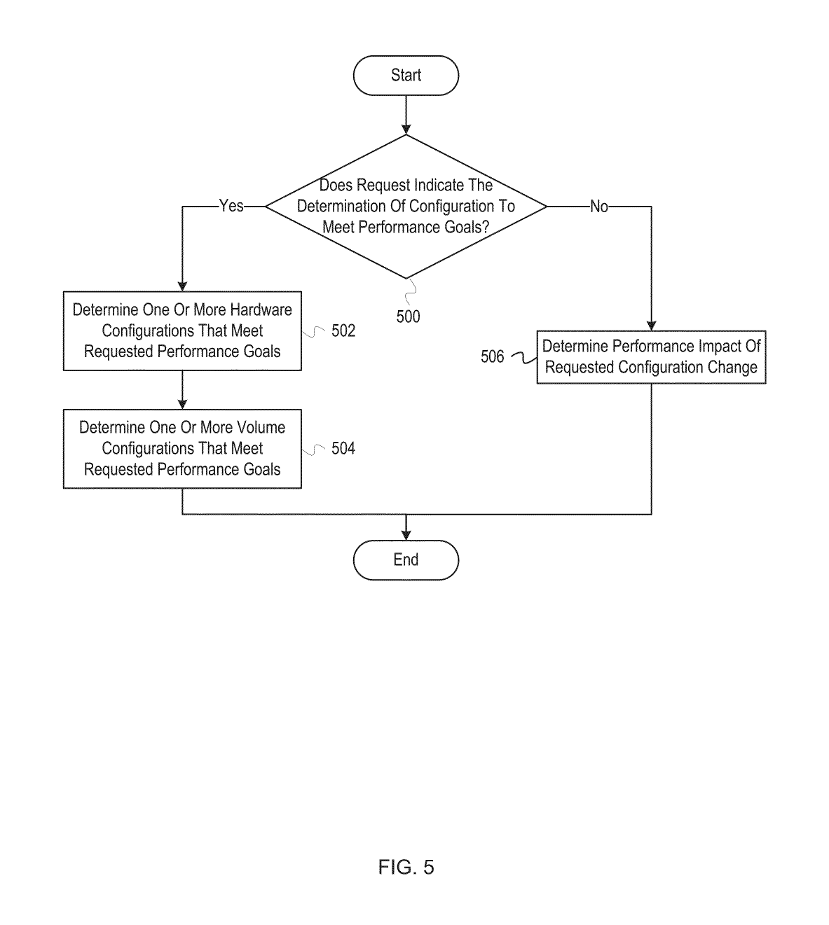

FIG. 5 depicts a flowchart of example operations for determining configurations that meet performance goals and determining the performance impact of configuration changes. The operations depicted in FIG. 5 can be performed by the storage analyzer 108 and/or the storage controller analyzer 122 depicted in FIG. 1, but is not limited to the implementations described above.

At block 500, the storage analyzer determines whether a request indicates that a configuration that meets performance goals should be determined. The storage analyzer might determine whether the request indicates that a configuration should be determined by checking a request type, the contents of the request, etc. If the storage analyzer determines that the request indicates that a configuration should be determined, control then flows to block 502. If the storage analyzer determines that the request does not indicate that a configuration should be determined, control then flows to block 506.

At block 502, the storage analyzer determines one or more hardware configurations that meet the requested performance goals. The storage analyzer can determine the hardware configurations in a variety of ways. For example, a hardware configuration database might include data indicating the performance capabilities of various hardware configurations. The storage analyzer might query such a hardware configuration database by specifying the performance goals requested. The hardware configuration database might then return results that meet the performance goals requested. A query, or the hardware configuration database itself, may translate the requested performance goals into a range of values. For example, the hardware configuration database might return results that are within ten percent of the performance goals specified (either above, below, or a combination thereof). Cost can be taken into account as well. For example, a hardware configuration database can include a cost estimate associated with various hardware configurations. When multiple results are responsive to a particular query, the storage analyzer (or hardware configuration database) can exclude solutions that are above a particular cost. Further, a particular budget might be specified in the request. The budget can then be taken into account when determining the hardware configurations.

Further, candidate hardware configurations can be associated with a relevance. For example, the cost of a particular candidate hardware configuration might increase or decrease the relevance of the particular candidate hardware configuration. Further, the determination of the hardware configurations can take into account an existing hardware configuration. Thus, if a particular storage system includes a particular controller and particular storage devices, the determination might focus on hardware configurations that include the particular controller or particular storage devices. Consider a hardware configuration that includes a controller that can utilize either Fibre Channel or iSCSI for network connectivity and multiple storage devices that have expandable cache memory. The storage analyzer might determine that utilizing iSCSI for the controller connectivity and increasing the amount of cache memory can meet the performance goals. Such a hardware configuration might be determined to be more relevant than one that requires changing out the storage devices or controller (for reasons potentially including cost, ease of implementation, etc.).

A hardware configuration database can include specific hardware configurations or subsets of hardware configurations that indicate the performance impact of the subsets. Instead of indicating every combination of hardware possible, the hardware configuration database can indicate aspects of a hardware configuration and quantify the impact relative to related hardware configurations. For example, the hardware configuration database might group connectivity technology, such as Fibre Channel and iSCSI, and indicate the potential impact of switching between the different connectivity technologies. Thus, the entries in the hardware configuration database can be processed to provide various permutations of hardware configuration options that meet the requested performance goals.

Further, the data included in a hardware configuration database can vary based on the location of the hardware configuration database. For example, while a single, centralized hardware configuration database might include a broad range of hardware configuration data, a hardware configuration database located on a controller might include a subset of hardware configurations relevant to the controller. For example, controllers might be limited in various ways, such as connectivity options, cache size, etc. Thus, the controller might have a hardware configuration database that only includes data for hardware configurations that are possible for that particular controller.

The determination of the hardware configurations that meet the requested performance goals is not limited to reliance on semi-static data (i.e., static but updateable), such as a database. For example, a controller might include the ability to select one of a plurality of cache replacement options (such as least recently used, most recently used, random replacement, etc.). Instead of referring to a particular database for performance-related data, the controller might dynamically determine the performance impact of changing the cache replacement option. For example, the controller might temporarily change the cache replacement option and measure the performance impact under actual use. Further, the controller might simulate the impact of the cache replacement option based on previous usage.

As illustrated above, the hardware configurations can include software and/or firmware configurations that are related to particular hardware. After the storage analyzer determines the one or more hardware configurations that meet the requested performance goals, control then flows to block 504.

At block 504, the storage analyzer determines one or more volume configurations that meet the requested performance goals. The storage analyzer can determine the volume configurations using techniques similar to those described above at block 502. For example, the storage analyzer might query a volume configuration database for volume configurations that meet the requested performance goals. Volume configurations include the logical volume layout, block sizes, RAID configuration settings, etc. For example, the storage analyzer might determine that implementing a RAID 5 configuration utilizing 128 kilobyte stripe segments across five drives will meet the requested performance goal. After the storage analyzer determines the one or more volume configurations that meet the requested performance goals, the process ends.

Control flowed to block 506 if, at block 500, the storage analyzer determined that the request does not indicate that a configuration should be determined. At block 506, the storage analyzer determines the performance impact of a configuration change indicated in the request. The request might indicate a variety of possible configuration changes, including upgrading storage devices, changing to a different connectivity technology, upgrading firmware, modifying RAID settings, etc. The configuration change can also include designing a new storage system. The storage analyzer might determine the performance impact of a requested configuration change using techniques similar to those described at blocks 502 and 504. For example, if the requested configuration change is to a hardware configuration, the storage analyzer might query a hardware configuration database. However, instead of querying a hardware configuration database for entries based on performance goals, the storage analyzer queries the hardware configuration database for entries based on the existing configuration and the new configuration. In other words, the storage analyzer might query for the performance data related to a controller currently used in a storage system and a controller indicated in the request as being a possible upgrade. The storage analyzer can then compare the performance of the original controller and the new controller to determine the performance impact. Further, the storage analyzer might dynamically determine the performance impact of the indicated configuration change by testing or simulating the particular change. After the storage analyzer determines the performance impact of a configuration change indicated in the request, the process ends.

While hardware and volume configurations are described separately, above, many aspects of the two can overlap and/or work together. In other words, they are just two ways to divide the general concept of storage system configurations. Other techniques of grouping related configurations might be utilized as appropriate for a particular solution. For example, software configurations (such as cache replacement policy, I/O block size, etc.) might be viewed as separate from the actual hardware configurations (such as memory capacity, processor speed, etc.)

Some of the operations discussed herein are described as being performed by a storage analyzer. A storage analyzer can be a system dedicated to performing the operations discussed herein. A storage analyzer can also be part of another system, such as a multipurpose server, a storage controller, etc. Further, a particular storage system might have multiple storage analyzers, such as described in relation to FIG. 1. Multiple storage systems might share the same storage analyzer. For example, the storage analyzer 108, depicted in FIG. 1, might be part of a central computing system that is used by multiple storage systems.

Many aspects of the disclosures herein can be further explained via use cases. Consider a scenario in which one or more drives within a storage system are to be replaced by higher capacity drives. Information used to determine the impact of such an upgrade might not be readily available. For example, in a complex storage system, logical volumes might be setup to utilize drives from multiple storage devices, and individual storage devices may include drives used by multiple logical volumes. Thus, determining the impact of upgrading specific drives can be tedious, as information about each individual drive is used. However, upon receiving an indication that one or more drives are to be upgraded, a storage analyzer can quickly determine the current configuration and how upgrading the drives will impact the storage system. For example, if three drives are indicated as potentially being upgraded, the storage analyzer can indicate if any of the three drives are part of a particular volume. In other words, the storage analyzer can determine whether replacing any of the drives might result in an error. Further, the storage analyzer can indicate that the error can be prevented by taking the affected volumes offline. The storage analyzer can also warn of potential performance loss due to mismatched drive parameters (such as utilizing a 7200 RPM drive in an array of 15 k RPM drives) and indicate relevant statistics (such as how much of a capacity increase the drive upgrades will result in broken down by volume affected volume, how much performance will be impacted, etc.). The storage analyzer can also provide step-by-step instructions for upgrading the drives while maintaining storage system performance and data as best as possible and providing validation requirements to ensure other issues do not arise. An implementation to facilitate this scenario might include a user interface to allow the inputting and display of the relevant information. A central storage analyzer can determine in which storage devices the specific drives are located and send requests for further analysis to storage analyzers on related controllers. The storage analyzers on the controllers can then send requests for further analysis to storage analyzers on the storage devices, etc. Each storage analyzer can respond to the parent storage analyzer (the storage analyzer making the request) with the results of the analysis and configuration information. Each parent storage analyzer can then combine the information as appropriate and return the combined information to its parent storage analyzer.

Consider a similar scenario in which the capacity of a volume is to be increased. In some implementations, such a modification can be performed without restricting access to the volume (i.e., the upgrade can be performed without losing data or taking the volume offline). However, such an upgrade can impact performance of the volume. A storage analyzer might determine the current usage of the particular volume, such as how many users are accessing the volume and the amount of data being transferred. The storage analyzer might utilize historical data to determine if the current usage is high, and recommend performing the change or waiting until another time when the usage is lower.

Consider a scenario in which a set of drives used in a RAID array are to be initialized. A storage analyzer might receive a request to determine, or estimate, the length of time it will take to initialize the set of drives. The length of time (in seconds) it will take to initialize a set of drives can be estimated by the following equation:

$$\frac{\frac{v s}{s s} \times \frac{1}{n}}{I O P S} \qquad Equation 1$$

Where vs is the size of the volume in terabytes, ss is the RAID segment size, n is the number of drives in the volume group, and IOPS is the number of I/O operations per seconds used to initialize the set of drives. The volume size and segment size are configurable RAID array options that can be configured during setup of the RAID array (and possibly modified afterwards). The number of IOPS available can depend on many different factors, such as the drive speed (e.g., spindle RPM), connectivity technology (e.g., Fibre Channel, Serial Attached SCSI, etc.), etc. As described above, complex storage systems can comprise many different RAID arrays comprising many different drives. Each of the parameters in Equation 1 can vary between RAID arrays, thus resulting in potentially time consuming collection of data. However, a storage system analyzer can communicate with the storage system components, thus allowing the storage system analyzer to quickly determine the parameters.

The above use cases, as well as other example use cases described in the examples, are used to further explain the operations described herein. Many other use cases exist and can vary between implementations.

As example flowcharts, FIGS. 2, 4, and 5 present operations in an example order from which implementations can deviate (e.g., operations can be performed in a different order than illustrated and/or in parallel; additional or fewer operations can be performed, etc.). For example, FIG. 2 depicts a storage analyzer performing at least a portion of a storage configuration analysis (block 202) and sending indications to one or more other storage analyzers indicating that the other storage analyzers should perform a portion of the analysis (block 208). While these operations are described as being performed sequentially, the storage analyzer can send the indications while also performing the analysis, thus allowing the other storage analyzers to perform their portion of the analysis in parallel.

As will be appreciated by one skilled in the art, aspects of the disclosures herein may be embodied as a system, method or computer program product. Accordingly, aspects of the disclosures herein may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the disclosures herein may take the form of a program product embodied in one or more machine readable medium(s) having machine readable program code embodied thereon.

Any combination of one or more machine readable medium(s) may be utilized. The machine readable medium may be a machine readable signal medium or a machine readable storage medium. A machine readable storage medium may be, for example, a system, apparatus, or device that uses electronic, magnetic, optical, electromagnetic, infrared, or semiconductor technology, or a combination thereof. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium does not include transitory, propagating signals.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Program code for carrying out operations for aspects of the disclosures herein may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine. Examples of a machine that would execute/interpret/translate program code include a computer, a tablet, a smartphone, a wearable computer, a robot, a biological computing device, etc.

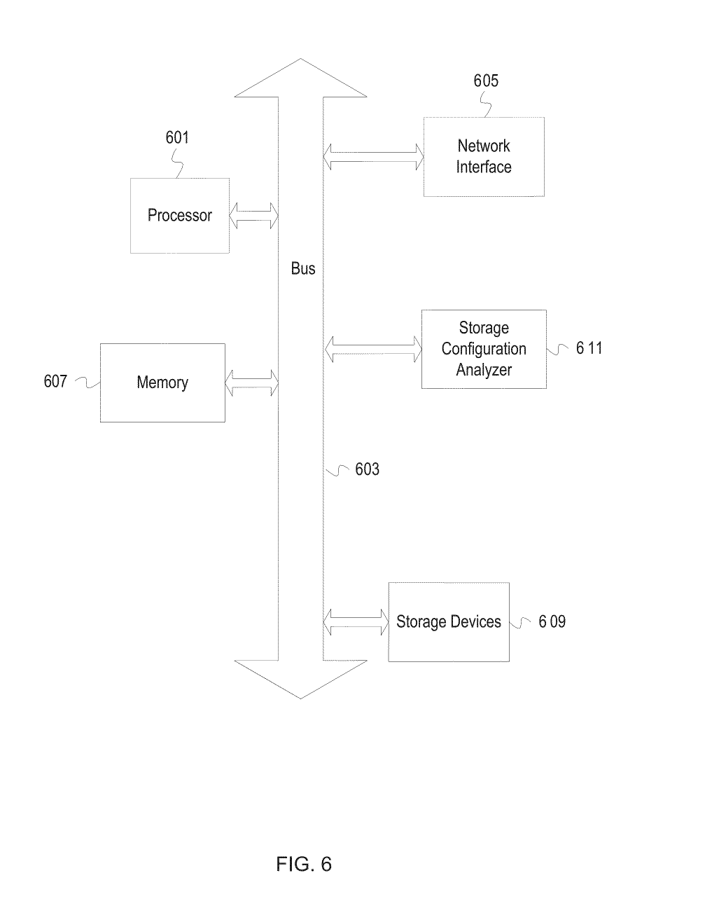

FIG. 6 depicts an example computer system including a storage configuration analyzer. A computer system includes a processor 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport®, InfiniBand®, NuBus, etc.), a network interface 605 (e.g., an ATM interface, an Ethernet interface, a Frame Relay interface, SONET interface, wireless interface, etc.), a storage device(s) 609 (e.g., optical storage, magnetic storage, etc.), and a storage analyzer 611. The storage analyzer 611 collects data about a storage configuration (e.g., indicated in a request), and analyzes the collected data to determine impact upon a system. The storage analyzer 611 may present the bare impact (e.g., resulting error, performance impact, etc.), may present suggestions to avoid determined impact, may present both the impact and suggestions to avoid the impact, etc. The functionality of the storage analyzer 611 can be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601, the storage device(s) 609, and the network interface 605 are coupled to the bus 603. Although illustrated as being coupled to the bus 603, the memory 607 may be coupled to the processor 601.

While the aspects of the disclosures herein are described with reference to various implementations and exploitations, it will be understood that these aspects are illustrative and that the scope of the disclosures herein is not limited to them. In general, techniques for efficiently evaluating storage system configurations as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosures herein. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the disclosures herein.

As used herein, the term “or” is inclusive unless otherwise explicitly noted. Thus, the phrase “at least one of A, B, or C” is satisfied by any element from the set {A, B, C} or any combination thereof.

What is claimed is:

1. A method comprising:
performing a first portion of a distributed storage configuration analysis in response to a request to perform the distributed storage configuration analysis;
determining that a storage system analyzer is capable of performing a second portion of the distributed storage configuration analysis that does not include the first portion of the distributed storage configuration analysis;
indicating to the storage system analyzer that the storage system analyzer is to perform the second portion of the distributed storage configuration analysis;
receiving results of the second portion of the distributed storage configuration analysis performed by the storage system analyzer; and
performing a third portion of the distributed storage configuration analysis based, at least in part, on the first portion of the distributed configuration analysis and the results of the second portion of the distributed storage configuration analysis.

2. The method of claim 1, wherein said performing the first portion of the distributed storage configuration analysis comprises:
determining a keyword associated with the distributed storage configuration analysis;
querying a database based, at least in part, on the keyword;
receiving, from the database, query results responsive to said querying the database; and
determining at least one of an error or a recommendation based, at least in part, on the third portion of the distributed storage configuration analysis;
wherein said performing the first portion of the distributed storage configuration analysis is based, at least in part, on the received query results.

3. The method of claim 2, wherein said querying the database comprises querying data that indicates at least one of a hardware configuration, volume configurations, performance metrics, compatibility data, configuration recommendations, or configuration restrictions.

4. The method of claim 1, wherein said receiving results of the second portion of the distributed storage configuration analysis performed by the storage system analyzer comprises receiving an indication that a change to a storage system configuration is capable of meeting a performance goal, wherein the storage system configuration is associated with the storage system analyzer, wherein the performance goal is indicated by the indication of the request.

5. The method of claim 1,
wherein said receiving results of the second portion of the distributed storage configuration analysis performed by the storage system analyzer comprises receiving an indication of a performance impact associated with a change to a storage system configuration, wherein the storage system configuration is associated with the storage system analyzer,
wherein said performing the third portion of the distributed storage configuration analysis based, at least in part, on the results of the second portion of the distributed storage configuration analysis comprises determining an overall performance impact based, at least in part, on the performance impact associated with the change to the storage system configuration.

6. The method of claim 1, wherein said determining that the storage system analyzer is capable of performing the second portion of the distributed storage configuration analysis comprises at least one of:
reading configuration data, wherein the configuration data identifies the storage system analyzer and indicates the second portion of the distributed storage configuration analysis; or
querying the storage system analyzer, wherein said querying the storage system analyzer comprises,
sending a query to the storage system analyzer;
receiving a response from the storage system analyzer, wherein the response indicates the second portion of the distributed storage configuration analysis.

7. The method of claim 1, wherein said performing the third portion of the distributed storage configuration analysis based, at least in part, on the results of the second portion of the distributed storage configuration analysis comprises aggregating the results of the second portion of the distributed storage configuration analysis with the results of at least one other portion of the distributed storage configuration analysis to determine a potential impact of a storage configuration change on a storage system.

8. A device comprising:
a processor; and
a machine readable storage medium having program code stored therein that is executable by the processor to cause the device to:
in response to a request to perform an analysis of a storage system associated with the device, determine that the request indicates at least one of a proposed storage configuration, a configuration validation request, or a set of performance goals;
determine configuration data associated with the device, wherein the configuration data includes configuration data for an additional device; and
perform the analysis of the storage system based, at least in part, on the configuration data associated with the device, wherein said program code being executable by the processor to cause the device to perform the analysis of the storage system based, at least in part, on the configuration data associated with the device comprises program code executable by the processor to cause the device to query a database for an entry associated with at least one of the device or the additional device.

9. The device of claim 8, wherein said program code being executable by the processor to cause the device to perform the analysis of the storage system based, at least in part, on the configuration data associated with the device further comprises program code executable by the processor to cause the device to, in response to a determination that the request to perform the analysis of the storage system indicates a proposed storage configuration, at least one of:
determine a performance impact of the proposed storage configuration based, at least in part, on the configuration data, the proposed storage configuration, and the database entry;
determine a restriction associated with the proposed storage configuration, wherein the determination of the restriction is based, at least in part, on the configuration data, the proposed storage configuration, and the database entry; or
determine a recommendation associated with the proposed storage configuration, wherein the determination of the recommendation is based, at least in part, on the configuration data, the proposed storage configuration, and the database entry.

10. The device of claim 8, wherein said program code being executable by the processor to cause the device to perform the analysis of the storage system based, at least in part, on the configuration data associated with the device further comprises program code executable by the processor to cause the device to, in response to a determination that the request to perform the analysis of the storage system indicates a configuration validation request, at least one of:
determine a restriction associated with a current storage configuration, wherein the determination of the restriction is based, at least in part, on the configuration data, the current storage configuration, and the database entries; or
determine a recommendation associated with the current storage configuration, wherein the determination of the recommendation is based, at least in part, on the configuration data, the current storage configuration, and the database entry.

11. The device of claim 8, wherein said program code being executable by the processor to cause the device to perform the analysis of the storage system based, at least in part, on the configuration data associated with the device further comprises program code executable by the processor to cause the device to, in response to a determination that the request to perform the analysis of the storage system indicates a performance goal, determine a storage configuration that is capable of meeting the performance goal based, at least in part, on the database entry.

12. The device of claim 8, wherein said program code being executable by the processor to cause the device to perform the analysis of the storage system based, at least in part, on the configuration data associated with the device further comprises program code executable by the processor to cause the device to:
determine that the additional device can perform a subset of the analysis of the storage system, wherein the determination that the additional device can perform the subset of the analysis of the storage system is based, at least in part, on the configuration data;
send a request to perform the subset of the analysis of the storage system to the additional device; and
receive a result of the subset of the analysis of the storage system from the additional device; and
combine the results of the subset of the analysis of the storage system received from the additional device with an additional subset of the analysis of the storage system to produce a result for the analysis of the storage system.

13. The device of claim 8, wherein said program code is executable by the processor to further cause the device to determine performance data associated with the device, wherein the performance data associated with the device was recorded during prior operation of the device.

14. The device of claim 8, wherein said program code being executable by the processor to cause the device to perform the analysis of the storage system based, at least in part, on the configuration data associated with the device further comprises program code executable by the processor to cause the device to estimate the length of time for initializing a logical volume, based, at least in part, on a logical volume size, a segment size, a number of storage devices, and a number of input/output operations per second available for performing the initialization.

15. A non-transitory machine readable medium having stored thereon instructions for storage system configuration analysis, comprising machine executable code which, when executed by at least one machine, causes the at least one machine to:
in response to a request to perform an analysis of a storage system associated with a device, determine that the request indicates at least one of a proposed storage configuration, a configuration validation request, or a performance goal;
determine configuration data associated with the device, wherein the configuration data includes configuration data for an additional device; and
perform the analysis of the storage system based, at least in part, on the configuration data associated with the device, wherein said machine executable code which, when executed by the at least one machine, causes the at least one machine to perform the analysis of the storage system based, at least in part, on the configuration data associated with the device comprises machine executable code which, when executed by the at least one machine, causes the at least one machine to query a database for at least one entry associated with at least one of the device or the additional device.

16. The machine executable code of claim 15, wherein said machine executable code which, when executed by the at least one machine, causes the at least one machine to perform the analysis of the storage system based, at least in part, on the configuration data associated with the device further comprises machine executable code which, when executed by the at least one machine, causes the at least one machine to, in response to a determination that the request to perform the analysis of the storage system indicates a proposed storage configuration, at least one of:
determine a performance impact of the proposed storage configuration based, at least in part, on the configuration data, the proposed storage configuration, and the at least one database entry;
determine a restriction associated with the proposed storage configuration, wherein the determination of the restriction is based, at least in part, on the configuration data, the proposed storage configuration, and the at least one database entry; or
determine a recommendation associated with the proposed storage configuration, wherein the determination of the recommendation is based, at least in part, on the configuration data, the proposed storage configuration, and the at least one database entry.

17. The machine executable code of claim 15, wherein said machine executable code which, when executed by the at least one machine, causes the at least one machine to perform the analysis of the storage system based, at least in part, on the configuration data associated with the device further comprises machine executable code which, when executed by the at least one machine, causes the at least one machine to, in response to a determination that the request to perform the analysis of the storage system indicates a configuration validation request, at least one of:
determine a restriction associated with a current storage configuration, wherein the determination of the restriction is based, at least in part, on the configuration data, the current storage configuration, and the at least one database entry; or
determine a recommendation associated with the current storage configuration, wherein the determination of the restriction is based, at least in part, on the configuration data, the current storage configuration, and the at least one database entry;

18. The machine executable code of claim 15, wherein said machine executable code which, when executed by the at least one machine, causes the at least one machine to perform the analysis of the storage system based, at least in part, on the configuration data associated with the device further comprises machine executable code which, when executed by the at least one machine, causes the at least one machine to, in response to a determination that the request to perform the analysis of the storage system indicates a performance goal, determine a storage configuration that is capable of meeting the performance goal based, at least in part, on the at least one database entry.

19. The machine executable code of claim 15, wherein said machine executable code which, when executed by the at least one machine, causes the at least one machine to perform the analysis of the storage system based, at least in part, on the configuration data associated with the device further comprises machine executable code which, when executed by the at least one machine, causes the at least one machine to:
determine that the additional device can perform a subset of the analysis of the storage system, wherein the determination that the additional device can perform the subset of the analysis of the storage system is based, at least in part, on the configuration data;
send a request to perform the subset of the analysis of the storage system to the additional device; and
receive results of the subset of the analysis of the storage system from the additional device; and
combine the results of the subset of the analysis of the storage system received from the additional device with an additional subset of the analysis of the storage system to produce results for the analysis of the storage system.

20. The machine executable code of claim 15, wherein said machine executable code further comprises machine executable code which, when executed by the at least one machine, causes the at least one machine to determine performance data associated with the device, wherein the performance data associated with the device was recorded during prior operation of the device.
